(19) United States
(12) Patent Application Publication
(10) Pub. No.: US 2011/0223382 A1
(43) Pub. Date: Sep. 15, 2011

(54) HOUSING STRUCTURE

(75) Inventors: CHANG-HAI GU, Shenzhen City (CN); JIAN-PING ZHANG, Shenzhen City (CN); PO-FENG HO, Shindian (TW); JIA-HONG QU, Shenzhen City (CN)

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/910,938

(22) Filed: Oct. 25, 2010

(30) Foreign Application Priority Data
Mar. 15, 2010 (CN) 201010124120.4

(51) Int. Cl. B32B 7/04; B32B 3/24; B32B 3/26; B32B 15/08

(52) U.S. Cl. 428/136; 428/139

(57) ABSTRACT

A housing includes a metal member and a plastic member integrally formed with the metal member. The metal member defines a number of stepped holes. The stepped holes are filled with the plastic member. The plastic member and the metal member cooperatively define a flat surface of the housing.

### BACKGROUND

1. Technical Field

The present disclosure relates to housing structures.

2. Description of Related Art

Housings are one of the most important components of electronic devices, and are widely used in mobile phones, and personal digital assistants (PDAs). Housings of typical electronic device is generally made of metal or plastic. Since metal has high strength and good electromagnetic shielding effect, metal housings are more widely used in the electronic devices. However, metal housings can affect the signal from being transmitted or received. A plastic housing has a lighter weight, but lower strength.

Therefore, there is room for improvement within the art.

### BRIEF DESCRIPTION OF THE FIGURES

Many aspects of the housing structure can be better understood with reference to the following figures. The components in the figures are not necessarily drawn to scale, the emphasis instead being placed upon clearly illustrating the principles of the housing structure. Moreover, in the drawings like reference numerals designate corresponding parts throughout the several views.

FIG. 1 is an exploded view of an exemplary embodiment of a housing.

FIG. 2 is a cross-sectional view of the housing in FIG. 1, taken along line II-II.

FIG. 3 is a cross-sectional view of the housing in FIG. 1, taken along line III-III.

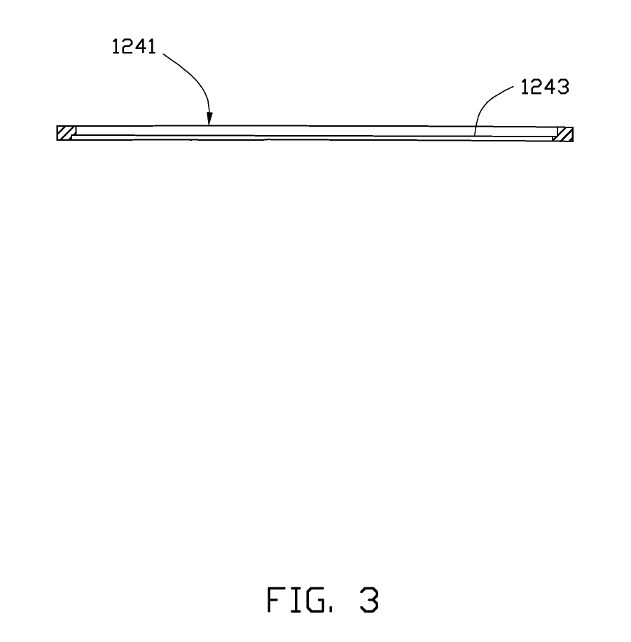

FIG. 4 is an assembled view of the housing in FIG. 1.

FIG. 5 is a cross-sectional view of the housing in FIG. 2 taken along line V-V.

FIG. 6 is a partial, enlarged view of the housing shown in FIG. 4.

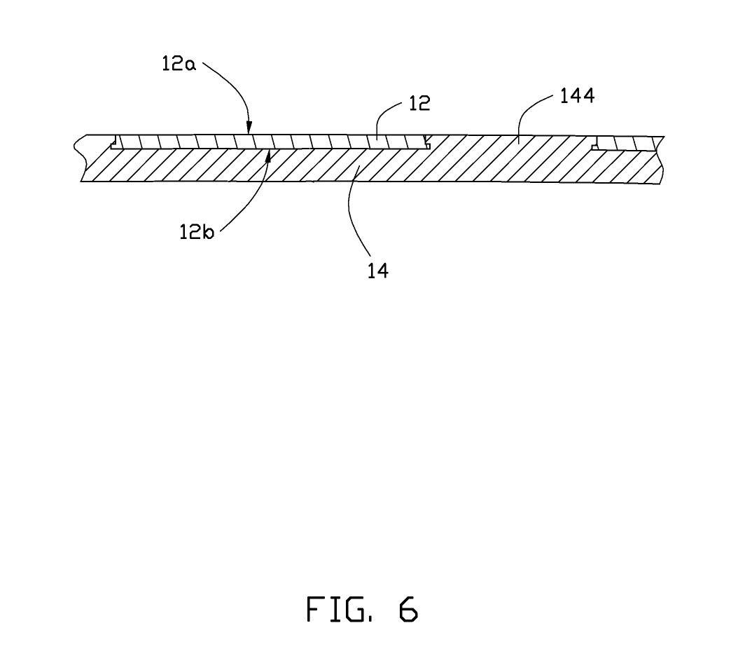

### DETAILED DESCRIPTION

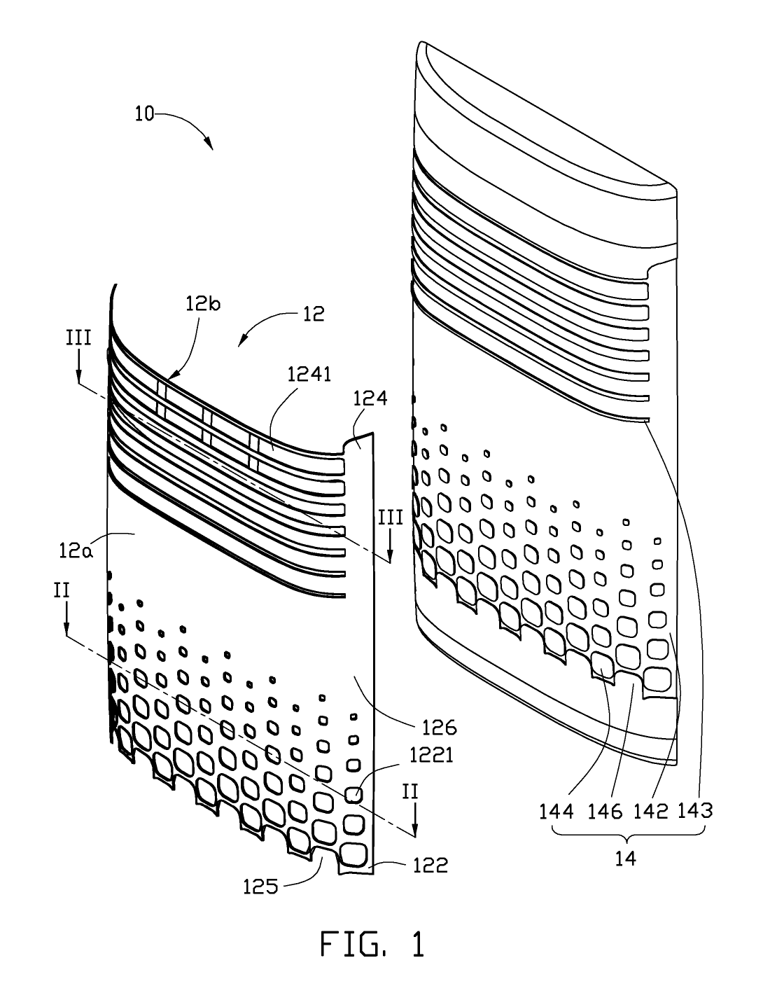

FIG. 1 shows an exemplary housing 10 used in an electronic device, such as a mobile phone, or a personal digital assistant. The housing 10 includes a metal member 12 and a plastic member 14 combined with the metal member 12.

The metal member 12 may be made of magnesium alloy, aluminum alloy, titanium alloy or stainless steel. The metal member 12 includes a first portion 122, a second portion 124 opposite to the first portion 122, and a connecting portion 126 connecting the first portion 122 to the second portion 124. The first portion 122 is adjacent to an end of the metal member 12, and the second portion 124 is adjacent to an opposite end of the metal member 12. The metal member 12 includes a first surface 12a and an opposite second surface 12b. The second surface 12b can be adhered to the plastic member 14.

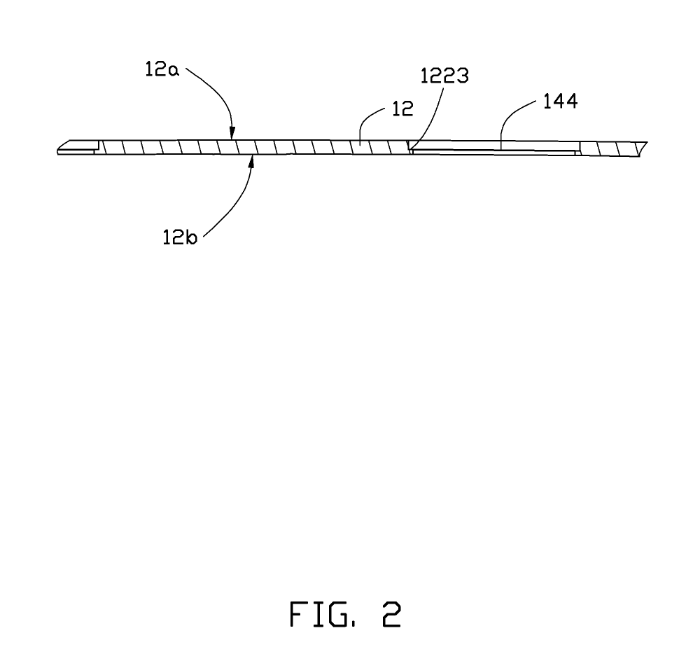

The first portion 122 defines a number of first stepped holes 1221. Referring to FIG. 2, the size of the portion of the first stepped holes 1221 defined in the first surface 12a is greater than the size of the portion of the first stepped holes 1221 defined in the second surface 12b. Thus, a step 1223 is formed in each first stepped hole 1221. The distribution density of the first stepped holes 1221 on the metal member 12 gradually decreases from near the first portion 122 toward the connecting portion 126. The size of the portion of the first stepped holes 1221 gradually becomes smaller from near the first portion 122 toward the connecting portion 126. The first stepped holes 1221 can be rectangular, triangular, or circular. In this exemplary embodiment, the first stepped hole 1221 is generally rectangular. The end of the first portion 122 defines a number of notches 125, to combine the metal member 12 tightly with the plastic member 14.

The second portion 124 defines a number of second stepped holes 1241. The size of the portion of the second stepped holes 1241 defined in the first surface 12a is greater than the size of the portion of the second stepped holes 1241 defined in the second surface 12b. Thus, a stepped portion 1243 is formed in each second stepped hole 1241. The second stepped holes 1241 are substantially strips, and are horizontally defined in two sides of the metal member 12. The distance of the second stepped holes 1241 on the metal member 12 gradually increases from near the second portion 124 toward the connecting portion 126. The width of the second stepped holes 1241 gradually becomes smaller from near the second portion 124 toward the connecting portion 126.

The plastic member 14 includes a main body 142, a number of first blocks 144 extending from near the main body 142, a number of second blocks 143, and a number of edge portions 146. The main body 142 can be attached to the metal member 12. The first blocks 144 and the second blocks 143 correspond to the first stepped holes 1221 and the second stepped holes 1241. In an exemplary embodiment, the first blocks 144 are generally rectangular, and the second blocks 143 are generally strips. The edge portions 146 correspond to the notches 125, and can be inserted into the notches 125. The plastic member 14 may be made of a moldable plastic. The moldable plastic may be one or more thermoplastic materials selected from a group consisting of polycarbonate (PC), acrylonitrile-butadiene-styrene (ABS), polymethyl methacrylate (PMMA), butylene terephthalate (PBT), and phenylene sulfide (PPS).

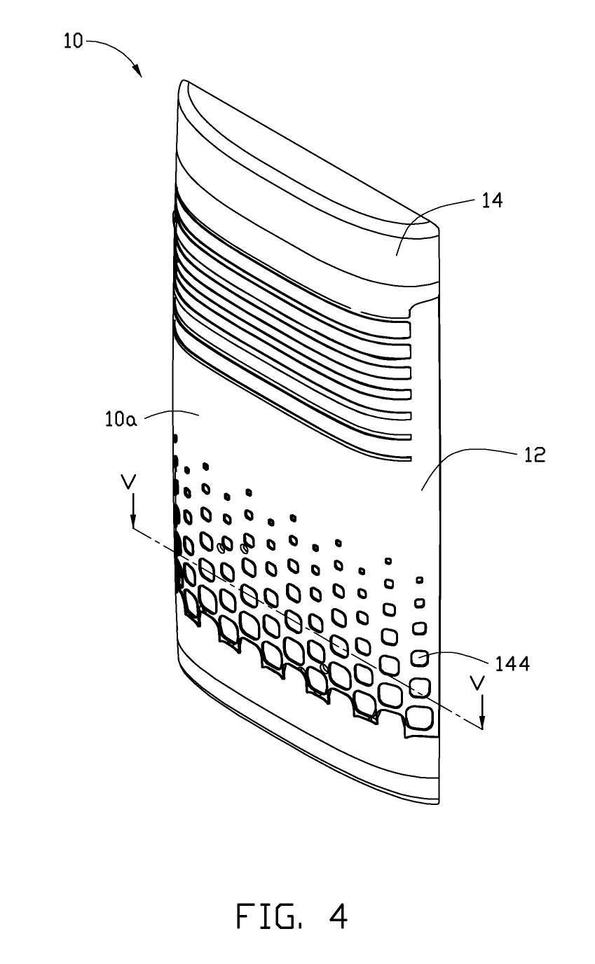

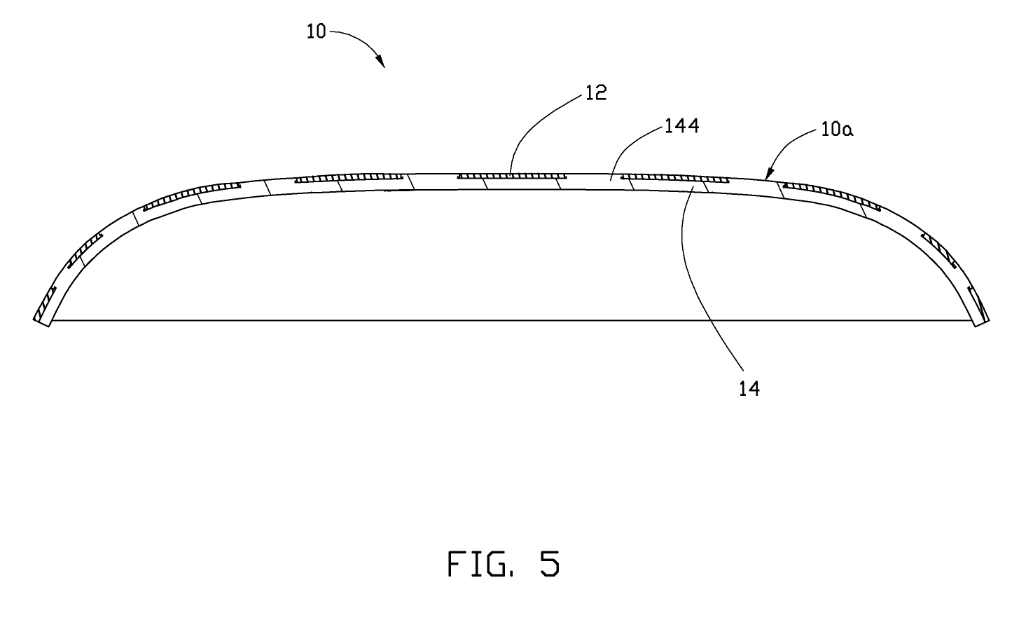

Referring to FIG. 4 and FIG. 5, the first blocks 144 and the second blocks 143 are inserted into the first stepped holes 1221 and the second stepped holes 1241. The edge portions 146 are inserted into the notches 125. Thus, the metal member 12 is combined with the plastic member 14. The first blocks 144 and the second blocks 143 are flush with the first surface 12a to form a flat surface 10a. Since the first blocks 144 and the first stepped holes 1221 are on one side, and the second stepped holes 1241 and the second blocks 143 are on the other side. The bonding force can be secure on both sides of the metal member 12 and plastic member 14. In addition, the second stepped portion 1241 and the first stepped holes 1221 include the stepped portions 1243 and 1223, the first blocks 144 and the second blocks 143 can match with the stepped portions 1243 and 1223. Thus, the bonding surface on both sides of the housing 10 can be secured.

In order to have a better aesthetic appearance, different color layers can be coated on the metal member 12 and the plastic member 14, such as color ink layers or paint layers. Therefore, a patterned effect can be obtained on the housing 10.

An exemplary embodiment of a method for making the housing 10 may include the following steps:

The metal member 12 is provided. The metal member 12 defines the first stepped holes 1221 and the second stepped holes 1241. The metal member 12 is integrally formed with the plastic member 14 to form the housing 10 by insert molding. The first stepped holes 1221 and the second stepped holes 1241 are filled with the plastic member 14. Therefore, the metal member 12 and the plastic member 14 cooperatively define the apparent surface 10a.

In another exemplary embodiment, the first stepped holes 1221 and the second stepped holes 1241 are also can be defined in the connecting portion 126.

The metal member 12 is combined with the plastic member 14 to form the housing 10. The second stepped holes 1241 and the first stepped holes 1221 include the stepped portions 1243 and 1223, the first blocks 144 and the second blocks 143 can match with the stepped portions 1243 and 1223. Thus, the bonding surface on both sides of the housing 10 can be secured. The first blocks 144 and the second blocks 143 have different shapes, thus, the metal member 12 is combined with the plastic member 14 tightly, and the apparent surface 10a is more attractive.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A housing, comprising:
a metal member defining a number of stepped holes; and
a plastic member integrally formed with the metal member, and the stepped holes filled with portions of the plastic member; the plastic member and the metal member cooperatively forming a flat surface.

2. The housing as claimed in claim 1, wherein the metal member comprises a first portion, a second portion opposite to the first portion, and a connecting portion connecting the first portion to the second portion; the stepped holes are defined in the first portion, the second portion, or the connecting portion.

3. The housing as claimed in claim 2, wherein the stepped holes are defined in the first portion and the second portion.

4. The housing as claimed in claim 2, wherein the distribution density of the stepped holes gradually decreases from near the first portion or near the second portion toward the connecting portion; the size of the portion of the stepped holes gradually becomes smaller from near the first portion or near the second portion toward the connecting portion.

5. The housing as claimed in claim 2, wherein the stepped holes defined in the first portion are generally rectangular, the stepped holes defined in the second portion are generally strips.

6. The housing as claimed in claim 1, wherein the metal member comprises a first surface and an opposite second surface, the size of the portion of the stepped holes defined in the first surface is greater than the size of the portion of the stepped holes defined in the second surface.

7. The housing as claimed in claim 1, wherein the metal member is made of magnesium alloy, aluminum alloy, titanium alloy or stainless steel.

8. The housing as claimed in claim 1, wherein the metal member defines a number of notches; the plastic member comprises a number of edge portions, the edge portions are inserted into the corresponding notches.

9. The housing as claimed in claim 1, wherein each stepped hole comprises a stepped portion, the plastic member matches with the stepped portions.

10. The housing as claimed in claim 9, wherein the plastic member comprises a main body, a number of blocks extending from near the main body, the blocks match with corresponding the stepped holes, the main body is adhered to the metal member.

11. A housing, comprising:
a metal member defining a number of stepped holes passing therethrough; and
a plastic member comprising a number of blocks engaging in corresponding stepped holes to define a flat surface with the metal member.

12. The housing as claimed in claim 11, wherein each stepped hole comprises a stepped portion, the blocks match with the stepped portions.

13. The housing as claimed in claim 11, wherein the metal member comprises a first surface and an opposite second surface adhered to the plastic member; the size of the portion of the stepped holes defined in the first surface is greater than the size of the portion of the stepped holes defined in the second surface.

14. The housing as claimed in claim 11, wherein the metal member defines a number of notches; the plastic member comprises a number of edge portions, the edge portions are inserted into the corresponding notches.

15. The housing as claimed in claim 11, wherein the metal member comprises a first portion, a second portion opposite to the first portion, and a connecting portion connecting the first portion to the second portion; the stepped holes are defined in the first portion, the second portion, or the connecting portion.

16. The housing as claimed in claim 15, wherein the stepped holes are defined in the first portion and the second portion.

17. The housing as claimed in claim 14, wherein the distribution density of the stepped holes gradually decreases from near the first portion or the second portion toward the connecting portion; the size of the portion of the stepped holes gradually becomes smaller from near the first portion or near the second portion toward the connecting portion.
